(19) United States
(12) Patent Application Publication
(10) Pub. No.: US 2009/0052183 A1
(43) Pub. Date: Feb. 26, 2009

(54) LIGHT-EMITTING MODULE

(75) Inventors: Tai-Ling Li, Gueishan Township (TW); Chi-Hao Liang, Tu Chen City (TW); Mong-Ting Tsai, Budai Township (TW)

Correspondence Address: Muncy, Geissler, Olds & Lowe, PLLC, P.O. BOX 1364, FAIRFAX, VA, 22038-1364, US

(73) Assignee: EVERLIGHT ELECTRONICS CO., LTD.

(21) Appl. No.: 12/038,599

(22) Filed: Feb. 27, 2008

(30) Foreign Application Priority Data
Aug. 23, 2007 (TW) 96131303

(51) Int. Cl. F21V 17/02

(52) U.S. Cl. 362/282

(57) ABSTRACT

A light-emitting module with a focus adjusting function is described. A light-emitting module includes a light-emitting diode, a first hollow cylinder and a second hollow cylinder. A first hollow cylinder encloses the light-emitting diode and has a first thread around an outer surface thereof. A second hollow cylinder has a second thread on an inner surface thereof, wherein the first thread is meshed with the first thread such that the second hollow cylinder is telescoped from the first hollow cylinder when the second hollow cylinder rotates relative to the first hollow cylinder. An optical lens is disposed within the second hollow cylinder, wherein the optical lens moves relative to the light-emitting diode so as to adjust a projected beam's focus.

### RELATED APPLICATIONS

This application claims priority to Taiwan Application Serial Number 96131303, filed Aug. 23, 2007, which is herein incorporated by reference.

### BACKGROUND

1. Field of Invention

The present invention relates to a light-emitting module.

2. Description of Related Art

Current light-emitting module design for LEDs tends to have a unique design for each different LED because each LED has its special optical demand. However, designing and manufacturing a new light-emitting module design is costly. There is a need for reducing costs in designing and manufacturing a new light-emitting module design.

### SUMMARY

It is therefore an objective of the present invention to provide a light-emitting module with a focus adjusting function.

In accordance with the foregoing and other objectives of the present invention, a light-emitting module includes a light-emitting diode, a first hollow cylinder and a second hollow cylinder. A first hollow cylinder encloses the light-emitting diode and has a first thread around an outer surface thereof. A second hollow cylinder has a second thread on an inner surface thereof, wherein the second thread is meshed with the first thread such that the second hollow cylinder is telescoped from the first hollow cylinder when the second hollow cylinder rotates relative to the first hollow cylinder. An optical lens is disposed within the second hollow cylinder, wherein the optical lens moves relative to the light-emitting diode so as to adjust a focus of a projected beam, which is emitted from the light-emitting diode through the optical lens.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a light-emitting module as described in an embodiment herein;

FIG. 2 illustrates how to operate the light-emitting module as illustrated in FIG. 1; and

FIG. 3 and FIG. 4 respectively illustrate how an LED and a lens operate as described in an embodiment herein.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

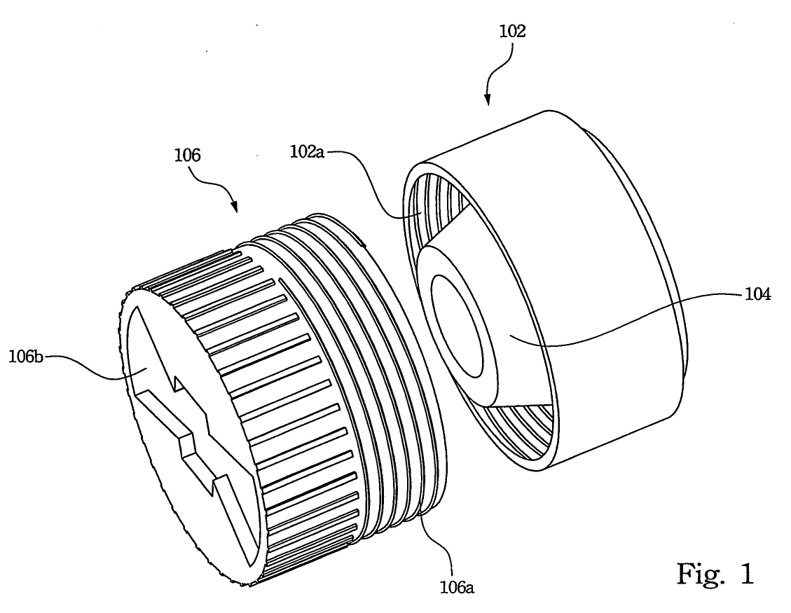

FIG. 1 illustrates a light-emitting module as described in an embodiment herein. The light-emitting module includes a hollow cylinder 102 and a hollow cylinder 106. The hollow cylinder 106A is equipped with a thread 106a around its outer surface, and the hollow cylinder 102 is equipped with a thread 102a in its inner surface. The thread 106a is meshed with the thread 102a when the hollow cylinder 102 and the hollow cylinder 106 are assembled. When the hollow cylinder 102 is rotated relative to the hollow cylinder 106, the hollow cylinder 102 can be telescoped from the hollow cylinder 106. An optical lens 104 is secured within the hollow cylinder 102.

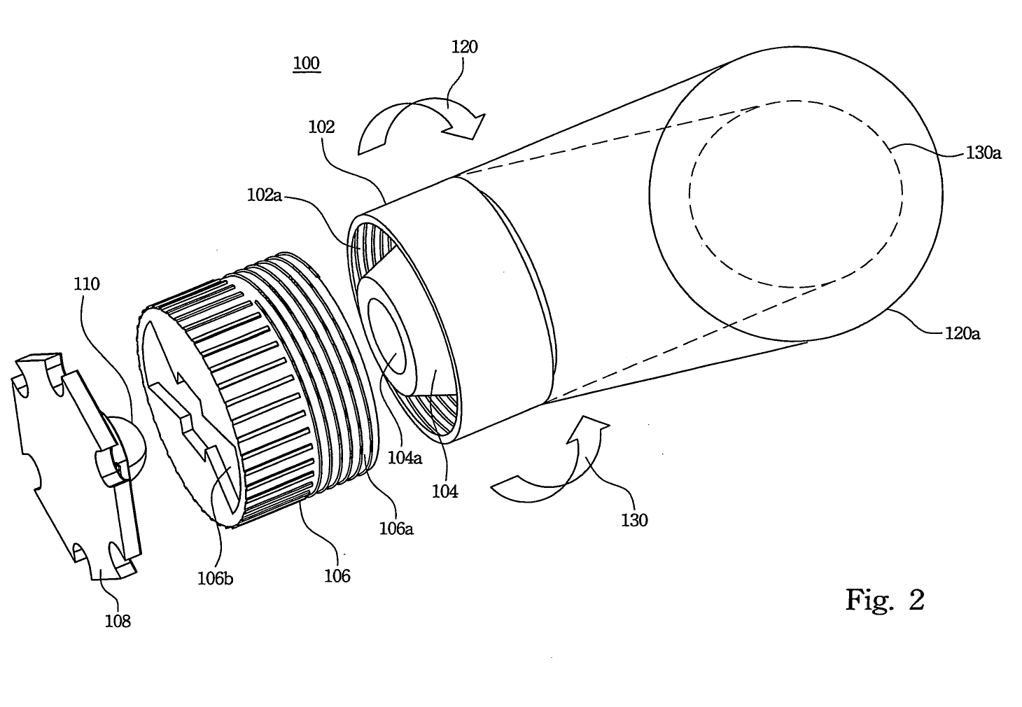

FIG. 2 illustrates how to operate the light-emitting module as illustrated in FIG. 1. A light-emitting diode 110, which is secured on a circuit board 108, is installed inside the hollow cylinder 106 via an opening 106b. The hollow cylinder 102 and the hollow cylinder 106 can be assembled by meshing the thread 106a with the thread 102a. When the hollow cylinder 102 and the hollow cylinder 106 are assembled, a light-receiving concave section 104a of the optical lens 104 surrounds or encloses the light-emitting diode 110. By rotating the hollow cylinder 102 relative to the hollow cylinder 106, the hollow cylinder 102 can be telescoped from the hollow cylinder 106 to adjust a distance between a bottom wall of the light-receiving concave section 104a and the light-emitting diode 110 such that a focus of a projected beam, which is emitted from the light-emitting diode through the optical lens, can be adjusted. For example, the hollow cylinder 102 can be rotated along a direction 120 to obtain a larger focused area 120a whereas the hollow cylinder 102 can be rotated along a direction 130 to obtain a smaller focused area 130a.

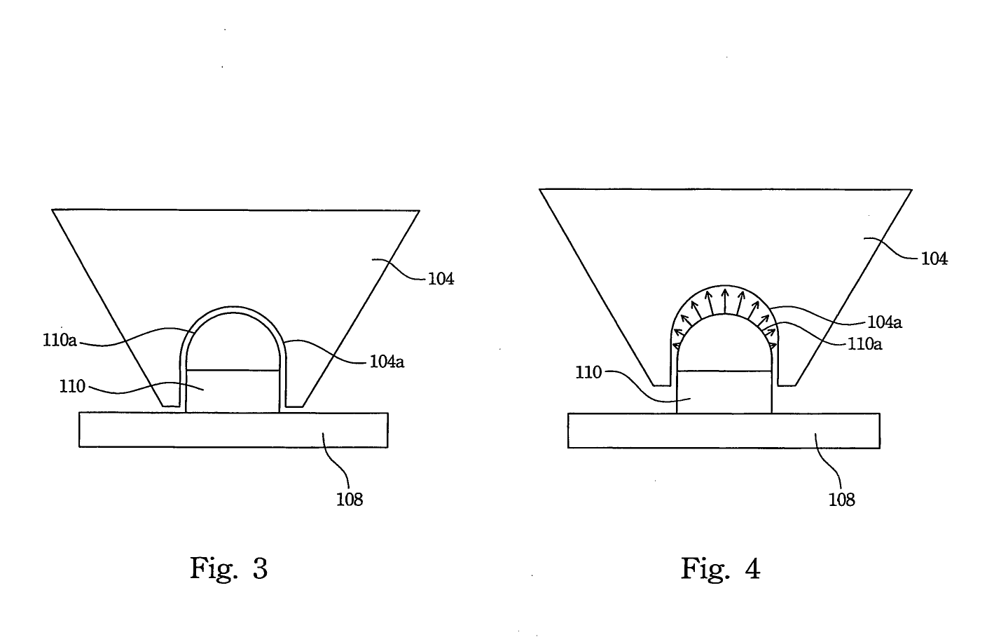

FIG. 3 and FIG. 4 respectively illustrate how an LED and a lens operate as described in an embodiment herein. In order to increase emitting efficiency of the light-emitting module, the light-emitting diode 110 should be surrounded by the light-receiving concave section 104a of the optical lens 104. In particular, the hollow cylinder 102 should be telescoped from the hollow cylinder 106 within a predetermined distance range, which keeps the light-receiving concave section 104a to surround a light-emitting surface 110a of the light-emitting diode 110 constantly. A depth of the light-receiving concave section 104a should be greater than a height of the light-emitting diode 110, i.e. from the circuit board 108 to an apex of the light-emitting surface 110a such that the light-receiving concave section 104a can fully surround the light-emitting surface 110a of the light-emitting diode 110 (as illustrated in FIG. 3). When the light-receiving concave section 104a's depth is greater than the light-emitting diode 110's height, the predetermined distance range, within which the hollow cylinder 102 can be telescoped from the hollow cylinder 106, can also be larger. FIG. 4 illustrates a longest distance to which the hollow cylinder 102 can be telescoped from the hollow cylinder 106. It is noted that the optical lens 104, the light-receiving concave section 104a and the light-emitting surface 110a should not be limited to the shapes illustrated in drawings, and persons skilled in the art can choose different shapes according their needs to accomplish a desired light-emitting module.

According to discussed embodiments, the light-emitting module's housing is divided into two separate parts, wherein one part including an optical lens can be telescoped from the other part so as to adjust a focus of a projected beam, which is emitted from the light-emitting diode through the optical lens. Therefore, the light-emitting module can be adaptable to various kinds of LEDs and to produce different types of projected beams.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A light-emitting module, comprising:
a light-emitting diode;
a first hollow cylinder enclosing the light-emitting diode and having a first thread around an outer surface thereof;
a second hollow cylinder having a second thread on an inner surface thereof, wherein the second thread is meshed with the first thread such that the second hollow cylinder is telescoped from the first hollow cylinder when the second hollow cylinder rotates relative to the first hollow cylinder; and
an optical lens disposed within the second hollow cylinder, wherein the optical lens moves relative to the light-emitting diode so as to adjust a focus of a projected beam, which is emitted from the light-emitting diode through the optical lens.

2. The light-emitting module of claim 1, wherein the optical lens comprises a light-receiving concave section.

3. The light-emitting module of claim 2, wherein the light-emitting diode comprises a light-emitting surface.

4. The light-emitting module of claim 3, wherein the second hollow cylinder is telescoped from the first hollow cylinder within a predetermined distance range, which keeps the light-receiving concave section to surround the light-emitting surface constantly.

5. The light-emitting module of claim 4, wherein the light-emitting surface is a convex surface.

6. The light-emitting module of claim 1, wherein the light-receiving concave section has a depth greater than a height of the light-emitting diode.
